(19) United States
(12) Patent Application Publication
(10) Pub. No.: US 2012/0048078 A1
(43) Pub. Date: Mar. 1, 2012

(54) ADJUSTABLE SICKLE BLADE HEAD

(75) Inventor: Günther Weber, Gross Nemerow (DE)

(73) Assignee: Weber Maschinenbau GmbH Breidenbach

(21) Appl. No.: 13/216,709

(22) Filed: Aug. 24, 2011

(30) Foreign Application Priority Data
Aug. 24, 2010 (DE) 10 2010 035 227.6

(51) Int. Cl. B26D 7/26; B26D 1/143

(52) U.S. Cl. 83/13; 83/699.51; 83/522.11

(57) ABSTRACT

A slicer is described for slicing food products that can be fed to a cutting blade that is rotatably arranged around a rotational axle in a bearing. The blade has the form of a sickle. The blade has an edge that has different radii distributed across its circumference. In the described slicers, cutting pressure can be controlled to adjust for diverse food products. Adjustments can be made by moving the bearing of the rotational axle of the sickle blade to different locations in a guide.

### CROSS-REFERENCES TO RELATED APPLICATION

This application claims priority based on German Patent Application No. DE 102010035227.6, filed Aug. 24, 2010, which is hereby incorporated by reference in its entirety.

### TECHNICAL FIELD

The invention relates to a device, particularly a high performance slicer, for slicing food products that can be fed with a conveyor to a cutting blade, which is rotatably arranged around a rotational axle in a bearing and which has the form of a sickle blade whose blade edge has different radii distributed across the circumference; the invention furthermore relates to a method for cutting a product, preferably a food product, that is fed to the cutting plane of a rotating sickle blade.

### BACKGROUND

Rotary blades that rotate around a rotational axle at a relatively high speed are known for cutting machines for foods. For the actual cutting process, the blades are guided past at the front of the food products by means of a feeding device, whereupon in each case, one slice or one product piece is cut off. The feeding path must be so long that the rotary blade is moved out sufficiently far for the feed motion of the product piece in order to make possible the feed of the food product before the next cutting process. Without such feeding devices, automatic slicing is not possible because the rotary blade is otherwise in the way of the product.

In the case of cutting devices of the type mentioned at the beginning, there also exist sickle blades with which the blade edge is guided in a sickle-like manner from a point near the bearing across the circumference to a point at a distance from the bearing. Normally there is a clearance angle between these two points. The clearance angle serves to make the transition of the different radii possible in a very short range. This area can furthermore be used for determining product data by using suitable sensors. The geometry of the blade edge of the sickle blade, together with the rotational speed, determines the cutting speed and the cutting pressure during the passage through the food product. A feeding device for the bearing of the blade is not needed, because the geometry of the sickle blade determines the cutting process. The blade edge is moved through the increasing radius with a rotation of the sickle blade through the product. After the cut, the radius returns to its minimal value as the rotation continues.

EP 407 883 A1 discloses such a sickle blade whose radius, considered across the circumference, continuously increases from a starting minimum value close to the bearing to a maximum value.

DE 3713536 A1 relates to a drive and bearing arrangement for a cutting head of a slicer with a main shaft held in a manner that allows it to be rotated with regard to the machine frame, whereby a support for a cutter shaft that supports a disc blade and that is arranged eccentrically with regard to the main shaft is attached to the main shaft. The main shaft and the cutter shaft are connected to each other and to a drive.

EP 1401619 B1 describes a method for registering the inner structure and outer contour of the product during the cutting.

### SUMMARY

The object of the present invention is to create a slicer with which the cutting pressure can be controlled and with which the cutting pressure allows an optimized cutting result for diverse food products.

The object is solved by a slicer in which the bearing of the rotational axle of the sickle blade is formed in a guide in a manner that allows movement to different locations.

Because the sickle head blade can be moved, or because of the adjustability of the rotational axle of the sickle blade, the advantage that is realized is that the cutting pressure exerted on the product by the cutting blade can be determined more exactly and more individually. Until now, the cutting pressure was determined solely by the blade edge profile and the radii of the sickle blade. If it was established for sickle blades that a different gradient was necessary, for example, because of a different product, it was necessary to manufacture a new sickle blade with exactly the required gradient. This complex and frequent calculation and production of different sickle blades is complex and expensive. By means of the present invention, different cutting angles, cutting pressures and cutting speeds can be realized in an amazingly simple manner with a sickle blade without it being necessary to design or manufacture new sickle blades for different applications. This considerably reduces the manufacturing and operating costs. The cutting angle is taken to mean the angle at which the blade cuts into the product. This angle, which changes relative to the horizontal due to the sickle blade geometry and the adjustment of the rotational axle, influences the cutting behaviour of the slicer.

According to a first embodiment of this invention, the rotational axle with its bearing can be slid in a parallel direction, so that the bearing point can be adjusted in the cutting plane of the sickle blade.

Because of the rotational axle, which is arranged so that it can be displaced relative to the product, the pressure on the product that is to be cut can be changed in an especially direct form. As a result, it is also possible to vary the respective cutting angle in a very advantageous manner.

A further embodiment provides for the bearing of the rotational axle of the sickle blade to be adjustable by means of a linear guide.

A linear adjustment of the rotational axle is especially advantageous because it can be carried out with very little effort and is reliable in operation.

A further advantageous embodiment provides for the bearing of the rotational axle of the sickle blade to be arranged in a manner that allows adjustment by means of a curved guide. The curved guide, which can be implemented by means of curved tracks, allows individually coordinated movements.

It is furthermore advantageous that the bearing of the rotational axle of the sickle blade can be adjusted by means of an eccentric guide.

The especially advantageous eccentric guide implements, in a simple manner, curved movements of the bearing of the sickle blade head in a direction relative to the product.

A favourable development of the invention results from the fact that the bearing of the rotational axle of the sickle blade is arranged on an arm that can be at least partially rotated around a pivot point at a distance from the rotational axle.

Due to this advantageous arrangement of the sickle blade head on a pivot arm, a circular sector movement of the rotational axle is achieved. The length of the arm, or the distance between the sickle blade rotational axle and the bearing point of the arm, defines the radius of the curved movement around which the adjustment can be made. The arm can also be formed in a manner that allows the length to be changed, in order to vary the movement of the bearing.

A preferred embodiment consists of a planetary gear, with the help of which the rotational axle of the sickle blade can be adjusted and the sickle blade itself can be made to rotate.

Due to this advantageous arrangement, two movements can be realized with one arrangement. Due to the planetary gear, it is also possible to adjust only the bearing of the rotational axle and to realize the rotation of the cutting blade itself by means of separate drives.

According to a further especially favourable development of the device, measuring devices for registering the cutting pressure, the cutting speed, the rotational speed and/or the cutting pattern are provided.

As a result, the special advantage of the movement control of the rotational axle of the sickle blade, this movement control depending on the speed, cutting pressure or cutting pattern, is first made possible. These sensor data can be fed to a corresponding control or regulating unit. Suitable as measuring devices are all known methods, such as counting the rotations or partial rotations using a magnet and Hall sensor arrangement or an optical registering of special measuring points, the inner structure or the outer contour.

Furthermore, especially due to these measuring devices of the structural registration, particularly in the case of non-homogenous structures, the individual components of the current cutting surface are recognized. Because these different areas have different physical characteristics, these data can be consulted for control or regulation of the movement of the blade rotational axle. For example, a fat layer in ham has a consistency that differs from that of the ham itself. The cutting behaviour that results from this can now also be considered in a very individual manner.

In principle, the widest range of possibilities can be implemented as a registering means for the inner structure. On the one hand, the current cutting surfaces can be registered by means of a camera and evaluated. The results of this evaluation can be registered by the regulating unit and taken into consideration for the movement of the rotational axle.

A possibility for registering the inner structure can be implemented, e.g., by an X-ray scanner that completely scans the product before the cutting process. Then all data regarding the inner structure and the outer contour are available before the cutting begins, so that the adjustment of the bearing of the rotational axle can be controlled according to these data.

The values regarding the cutting pressure can be especially advantageously used in order to regulate the adjustment of the bearing point of the rotational axle. Because the registering of the pressure in the product may be complex, it is proposed according to the invention that the pressure be registered at a point that supports the bearing of the sickle blade head and that is at a distance from the product. It is the reaction pressure that corresponds to the pressure of the blade in the product that is measured.

It is also especially advantageous that a control and/or regulating unit is provided for adjusting the support of the rotational axle, which allows selective changing of the bearing position.

A further advantageous embodiment provides for the bearing of the rotational axle to be adjusted depending on the measured values of the cutting process, using the control and regulating unit.

By means of this especially advantageous development, controlling or regulating the adjustment of the sickle blade head using the previously determined data of the product or of the cutting process is implemented.

The adjustability of the bearing of the rotational axle of the cutting blade depending on the inner structure and/or the outer contour of the product to be sliced by means of the control and regulating unit represents a further very advantageous embodiment of the present invention.

In this way, the cutting angle and the cutting pressure of the cutting blade are now adjusted to the actually existing current product consistency and product form, in an especially advantageous manner, in order to optimize the cutting result in this way.

The object is further solved by means of a method in which the bearing of the rotational axle of the sickle blade experiences a parallel displacement before and/or after and/or during the cutting process.

This advantageous embodiment also has the objective of achieving an optimal cutting result. The cutting pressure can be very individually adjusted to the product conditions. The adjustment of the rotational axle takes places during a rotation of the blade. It is also possible to adjust the bearing of the rotational axle before and/or after and/or during the cutting process.

According to a further especially favourable development of the invention, the bearing of the rotational axle is adjusted by a control and/or regulating unit and in this process, the physical characteristics (type, weight, consistency, structure, moisture, etc.) of the product to be sliced and/or operating data of the cutting process are used in order to change the position of the rotational axle.

By means of this further advantageous solution of the object, methods for cutting products in an especially favourable form are improved to the effect that the cutting quality displays a constantly good quality regardless of product irregularities or changes in the cutting process.

### BRIEF DESCRIPTION OF THE DRAWINGS

FIG. 1 depicts a front view of a first embodiment of a cutting device with a sickle blade arranged above a food product to be cut.

FIG. 2 depicts a front view of a cutting device from FIG. 1, whereby two salamis are present as food products.

FIG. 3 depicts a front view of a cutting device from FIG. 1, whereby a variation of different bearing points is shown.

FIG. 4 depicts a front view of a further embodiment with a sickle blade arrangement that can be displaced linearly above a food product that is to be cut and that is likewise held in a manner that allows it to be displaced.

FIG. 5 depicts a front view of a further embodiment with a sickle blade arrangement that can be adjusted by means of an eccentric, above a food product that is to be cut.

FIG. 6 depicts a front view of a further embodiment of a sickle blade arrangement that can be adjusted by means of a pivot arm.

FIG. 7 depicts a front view of a further embodiment with a planetary gear for adjusting the sickle blade arrangement.

FIG. 8 depicts a side view of a further embodiment of a cutting device according to the invention with a sickle blade, the height of which can be adjusted.

FIG. 9 depicts a front view of a further embodiment with a sickle blade head that can be adjusted in a plurality of directions.

FIG. 10 depicts a front view of a further embodiment with an adjustable sickle blade head that is held by two linear guides.

### DETAILED DESCRIPTION

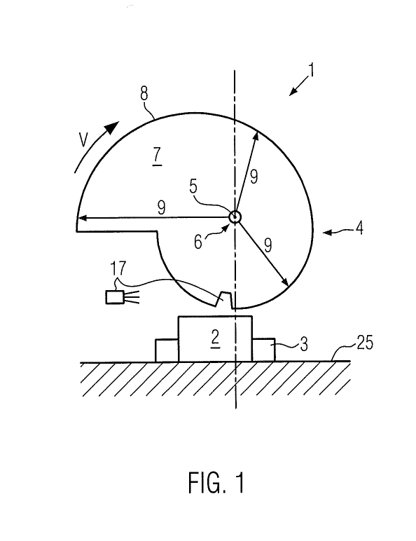

FIG. 1 shows a device 1 with a cutting blade 4 formed as a sickle blade 7, said cutting blade rotating around its rotational axle 5 at a rotational speed v. The rotational axle 5 of the sickle blade 7 is supported in a bearing 6 in such a way that the sickle blade can rotate. The radius 9 of the sickle blade 7 changes across the circumference of the same.

The sickle blade 7 is arranged above a block-like food product 2, e.g., a block of cheese, that can be moved in the feed direction by means of a conveyor 3, e.g., a sliding conveyor or a conveyor belt. Sensors 17 are arranged in such a way that they can be used to measure both the speed and the position of the cutting blade (notch as marking) as well as the rotational speed and the cutting pressure exerted on the product by the cutting blade. The cutting patterns of the cut product slices can furthermore be registered with the sensors 18 in order to carry out prompt changes of the cutting parameters by means of an evaluation.

Further embodiments are depicted in the following figures. The same reference numbers are fundamentally used for the same parts. For the sake of simplicity, only the changes are gone into.

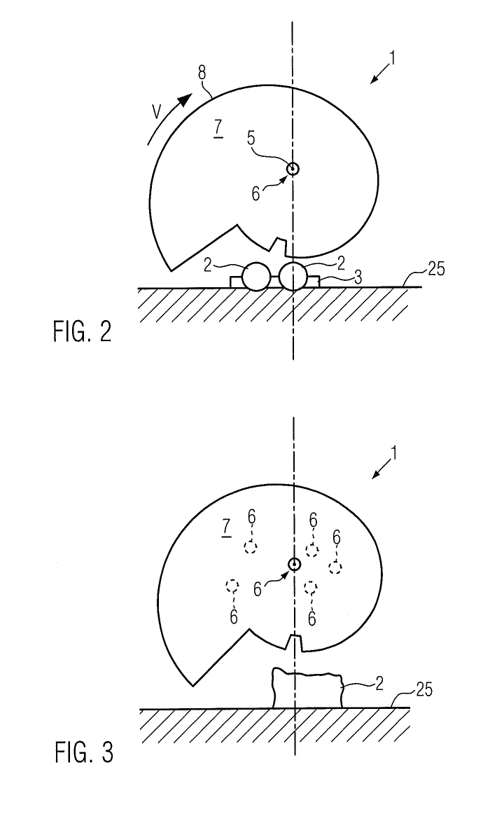

FIG. 2 shows the device 1 from FIG. 1. The sickle blade 7 has a blade edge 8 that is located around a radius at a distance from the rotational axle 5 of the sickle blade 7. The radius changes as the rotational angle of the sickle blade 7 increases, the radius preferably increasing with the rotation. Circle segments of the cutting blade are also possible, however, in which the radius remains constant with the rotation or even decreases. In the embodiment depicted here, two products that are round in the cross-section, such as two sausages, for example, are cut simultaneously with the sickle blade arrangement.

FIG. 3 shows the device 1 from FIGS. 1 and 2. Different bearing points 6 that such a bearing can take by adjusting the bearing 6 are indicated. Naturally any other possible bearing points are conceivable here. The food product 2 to be cut here has an irregular contour, such as occurs in natural food products such as ham, for example.

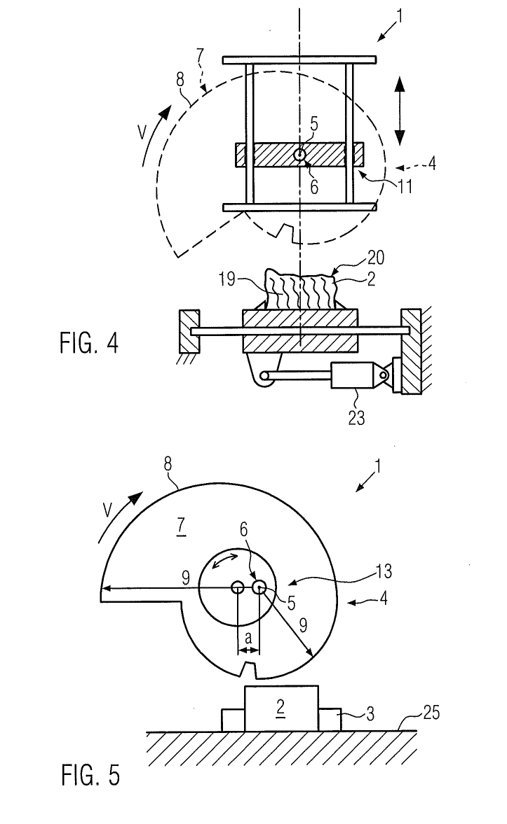

FIG. 4 shows a device 1 with a vertical linear guide 11 for the sickle blade 7. The bearing 6 of the rotational axle 5 of the sickle blade 7 can, due to this linear guide, be moved in the vertical direction relative to the food product 2 that is to be sliced. Due to the rotation of the sickle blade 7 and the movement of the bearing 6, the blade edge 8 can be very selectively guided through the product at certain cutting angles, said blade edge cutting the product.

The food product 2 is moved by a feeding movement on a conveyor 3 (not shown) to the cutting plane S. The drive 23 furthermore allows a movement of the product at a right angle to the feed. In this way, it is also possible to determine the point of the blade edge 8 that cuts the product. Further movements of the product, for example, in the direction of the cutting blade 4, are also possible. In principle, it can be provided that the product is adjusted in all directions in order further to achieve optimized cutting.

FIG. 5 shows a device 1 that has a sickle blade 7 with a blade edge 8 that rotates around a rotational axle 5 held in a bearing 6. As a result of the rotation of the sickle blade 7 at a speed v, the radius 9 of the sickle blade 7 also changes with respect to the product that is to be cut. The bearing 6 is moved on an eccentric disc 13. As a result, on the one hand the horizontal distance a between the rotational axle 5 and the centre point of the eccentric disc 13 changes, and on the other hand the vertical distance between the rotational axle 5 and the food product 2 changes. The food product 2 is also moved here on a conveyor 3 in the direction of the cutting plane S.

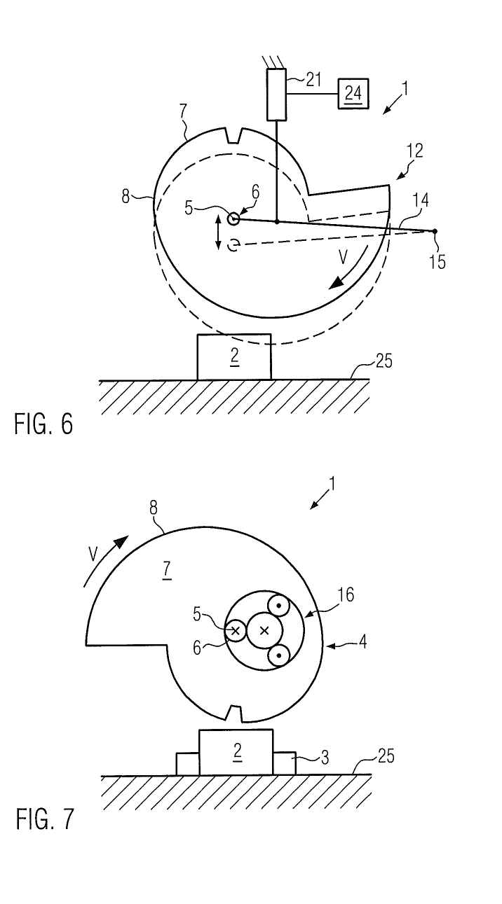

FIG. 6 shows a device 1 that has a rotational axle 5 of a sickle blade 7, said rotational axle being held in a bearing 6. The bearing 6 is arranged on an arm 14 that pivots around a pivot point 15. The arm 14 is pivoted around the point 15 by means of a rod that is, on the one hand, linked to the arm 14 and, on the other hand, driven by a drive, preferably an electric or electromagnetic drive, such as, for example, an electric cylinder or a servo drive. The bearing 6 is also adjusted by means of this pivoting movement. The rectangular food 2 depicted here could be, for example, a piece of cheese that is cut by the blade edge 8 of the sickle blade 7 that rotates at a speed v.

The arm 14 can also be formed in a telescopic manner. The length of this telescopic arm can be changed by a drive. A shaft-nut system, with a driven shaft and a nut fixed to the arm 14 or a cylinder-piston arrangement are possible drive developments that can be considered for driving the arm 14. All conceivable bearing points can be implemented by means of this optional change in the length of the arm 14, even independently of the specified tracks. Additionally shown in FIG. 6 is a control and regulating unit 24 with which, e.g., by means of the adjusting drive 21, the adjustment of the bearing point 6 can be adjusted depending on diverse parameters of the product and the cutting process, and, where applicable, the change in the length of the pivot arm 14 can be adjusted.

In the case of the embodiment of FIG. 7, the rotational axle 5 of the sickle blade 7 is adjusted by means of a planetary gear 16. The bearing point of the rotational axle is located in one of the planetary wheels. The food product 2 depicted here is, as already repeatedly described in the preceding, slid in the direction of the cutting blade 4 by a conveyor 3.

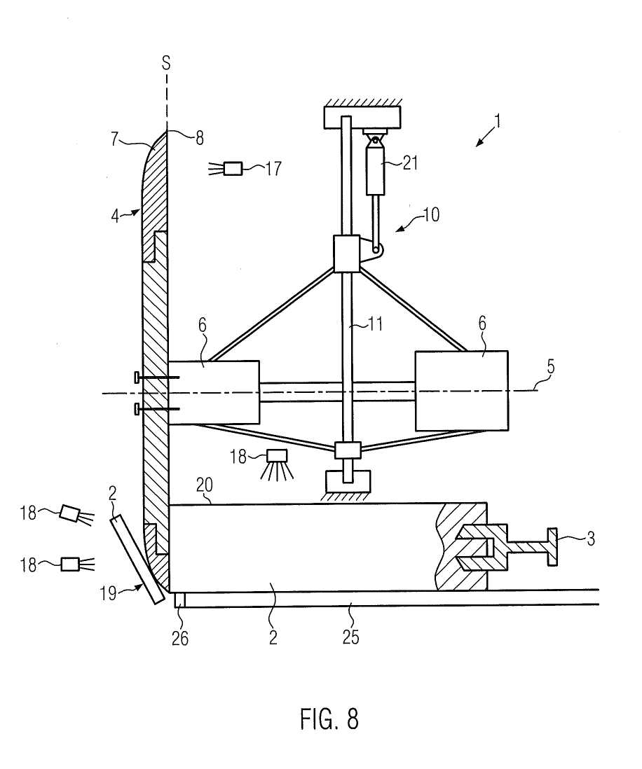

FIG. 8 shows a device 1 in the form of a slicer, in which the product that is to be cut, for example, a food product 2, is moved in the feed direction to the cutting level S by means of a conveyor 3 (bracket). Slices are sliced off of the product in the cutting plane S by the blade edge 8 of the rotating sickle blade 7. The food product 2 that is to be cut thereby lies on a support 25. In the area in which the cutting is carried out, the product lies on a cutting edge 26 that is preferably arranged in the immediate vicinity of the cutting plane S.

The sensors 17 can register the cutting speed, the rotational speed and the position of the blade. Cutting patterns of the cut product slices can furthermore be registered and evaluated by means of an arithmetic unit. The sensors 18 can be implemented by X-ray scanners or cameras, for example. They register the outer contour 20 and the inner structure 19 of the food product 2 that is to be sliced. The cutting pressure can additionally be determined by means of force sensors in the cutting edge. This takes place by means of recording the reaction forces. The bearing 6 of the rotational axle 5 of the sickle blade 7 can be adjusted by using the registered measurement data. A control and regulating unit correspondingly brings about a vertical adjustment movement of the bearing 6, which is guided in the vertical guide 10. The adjusting drives 21 serve to adjust the bearing point and the rotational axle 5.

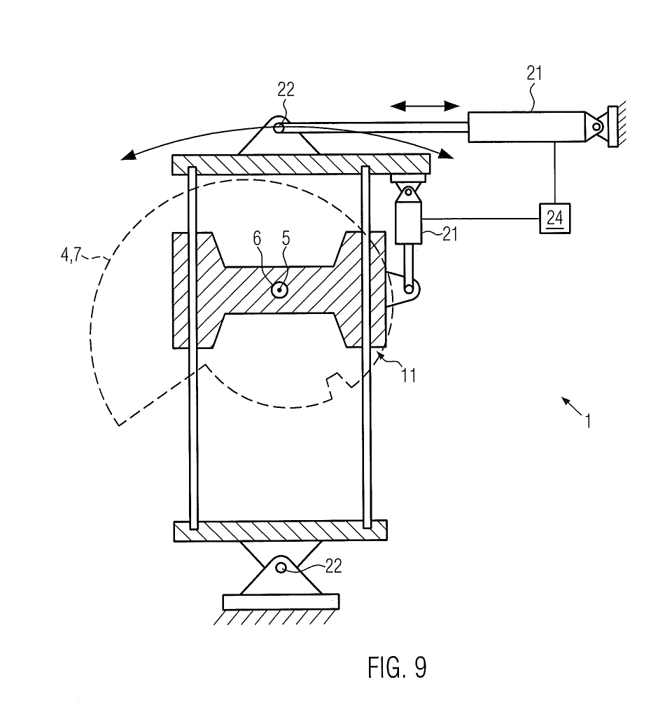

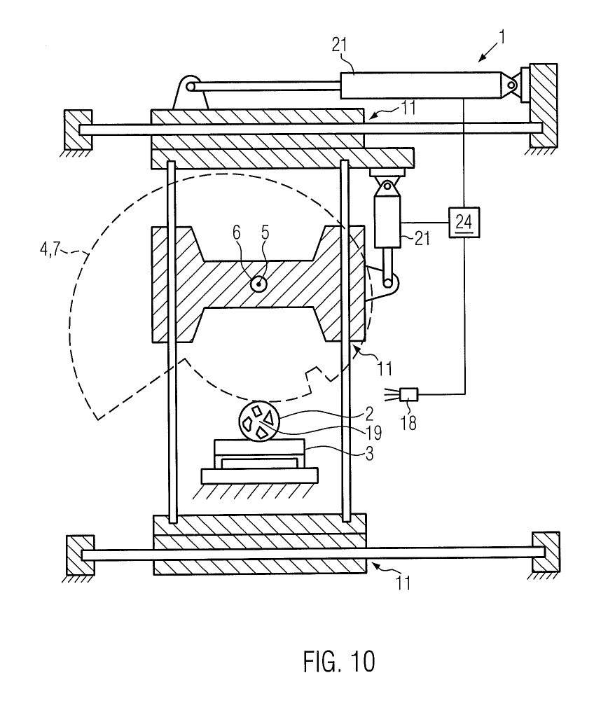

FIGS. 9 and 10 depict a plurality of guides that adjust the bearing 6. In FIG. 9, the bearing 6 is adjusted on the one hand by a vertical linear guide 11. The entire linear adjustment device can furthermore be adjusted here at an upper rotation point 22 in such a way that it can be pivoted around a lower pivot point 22. This movement is started by a drive 21 that, with a rod, acts on the upper pivot point 22. A further drive 21 serves the vertical adjustment of the bearing 6 in the vertical guide 11. A control and regulating unit 24 controls and regulates the drives 21 for adjusting the bearing 6. The measurement data from the sensors 17, 18 are thereby supplied to the control and regulating unit 24.

FIG. 10 shows a rotational axle 5 that is held in a bearing 6 and that can be adjusted in the vertical direction by a vertical linear guide pair 11. This adjustment device can furthermore also be adjusted in the horizontal direction by a horizontal linear guide pair 11. Due to these overlapping adjustment movements of the bearing 6, it is possible for the bearing 6 to take on any given location and to achieve an optimal cutting quality. The bearing 6 does not have to remain on the specified tracks, it being possible to move said bearing freely in the cutting plane S. The food product 2 depicted in FIG. 10 can be a ham sausage, for example.

The depicted sickle blade arrangements are used in cutting machines for slicing diverse products. Food products, such as sausage, cheese, ham, bread or other food products with a predominantly solid consistency, are frequently used as the products to be sliced.

These cutting machines are in many cases especially fast working high performance slicers with which food products are cut. The cuts can also be individually regulated or controlled depending on various parameters, such as product mass, product geometry, temperature or consistency, with these complex systems.

It is possible to change the slice thickness, the cutting pressure, the cutting angle and the cutting speed during the cutting process in order to achieve the optimal cutting quality of the specified target weights of the product slices.

1. A device for slicing food products, comprising:
a cutting blade rotatably arranged around a rotational axle in a bearing, the blade shaped in the form of a sickle having different radii extending from the axle to an outer edge of the blade distributed across a perimeter of the blade; and
the bearing is movable to different locations in a guide.

2. The device of claim 1,
characterised in that
the rotational axle with its bearing can be slid in a parallel direction, so that a bearing point can be adjusted in the cutting plane of the blade.

3. The device of claim 1
further comprising a linear guide for adjusting the bearing of the rotational axle of the blade.

4. The device of claim 1
further comprising a curved guide for adjusting the bearing of the rotational axle of the blade.

5. The device of claim 1,
further comprising an eccentric guide for adjusting the bearing of the rotational axle of the blade.

6. The device of claim 1,
characterised in that
the bearing of the rotational axle of the blade is arranged on an arm that can be at least partially rotated around a pivot point at a distance from the rotational axle.

7. The device of claim 1,
further comprising a planetary gear adapted to adjust the rotational axle of the blade or to drive the blade.

8. The device of claim 1,
characterised in that
the bearing of the rotational axle is adjustable in at least two different directions using at least two guides.

9. The device of claim 1,
characterised in that
the device has measuring devices for registering the inner structure and/or the outer contour of the food product and/or the cutting pattern.

10. The device of claim 1,
further comprising measuring devices for registering cutting pressure or cutting speed or rotational speed.

11. The device of claim 1
further comprising a control or regulating unit for adjusting the bearing of the rotational axle.

12. The device of claim 12,
characterised in that the control or regulating unit is adapted to adjust
the bearing of the rotational axle.

13. The device of claim 12,
characterised in that the control or regulating unit is adapted to adjust
the bearing of the rotational axle of the blade.

14. A method cutting a food product, comprising:
feeding the food product to a cutting plane of a rotating sickle blade; and
displacing the bearing of the rotational axle of the sickle blade in a direction parallel to the cutting plane before, during or after the sickle blade cuts the food product.

15. The method of claim 14, wherein displacing comprises adjusting the bearing of the rotational axle by a control or regulating unit based upon selected physical characteristics of the food product or cutting operating data.
